(19) United States
(12) Patent Application Publication
(10) Pub. No.: US 2012/0305643 A1
(43) Pub. Date: Dec. 6, 2012

(54) System and Method for Determining Eligibility of a Card Holder at a Point of Service

(75) Inventor: Malcolm C. Daniels, JR., Phoenix, AZ (US)

(73) Assignee: Code Marketing and Management, Inc.

(21) Appl. No.: 13/153,555

(22) Filed: Jun. 6, 2011

(51) Int. Cl. G06K 5/00

(52) U.S. Cl. 235/380

(57) ABSTRACT

A system and method are disclosed for determining eligibility of a card holder at a point of service by accessing personal identification information stored at a select application database. The system comprises a card holder identification card having a printed code identifying the card holder. A code server comprises a code database correlating card holder specific code record IDs and corresponding addresses associated with the select application database for providing personal identification information defining card holder eligibility. A processing device at the point of service is programmed to: read the card holder's printed code; convert the card holder's print code to a code record ID; and establish communication with the code server to transfer the card holder's code record ID to the code server. The code server is programmed to compare the received code record ID to the code database and return the address corresponding to the received code record ID to the processing device. The processing device is programmed to log onto the application database and use the returned address to download the personal identification information defining card holder eligibility for display on the processing device at the point of service.

### CROSS REFERENCE TO RELATED APPLICATIONS

There are no related applications.

### FIELD OF THE INVENTION

The present invention relates to a means and method for transmitting personal identification and other pertinent identifiable information, relative to eligibility as a recipient of Medicaid or other insured services, or the like, from a select database to a Medicaid, private insurance or other provider of services.

### BACKGROUND OF THE INVENTION

Congress created Medicaid in 1965 as Title XIX of the Social Security Act. Each state administers its own Medicaid program. The federal Centers for Medicare and Medicaid Services (CMS) monitor state-run programs and establish requirements for service delivery, quality, funding, and eligibility standards. Medicaid is voluntary for states, but every state participates.

State Governments are responsible for establishing and enforcing the standards mentioned above of a resident's eligibility, validation and use of Medicaid and Social Services and programs. Most States implement and accomplish this through the issuance of State Medicaid ID cards which usually do not include a photo of the approved recipient and are otherwise limited in the amount of identifying information.

Particularly, each State in the Union has similar obligations to its citizens, one of which is health care. Medicaid is the provision of health care to those citizens of the State who have no health insurance or other means to pay for it. The timely accessibility of correct eligibility information and certification is absolutely essential to the rightful delivery of competent health care at all times, whether the care is delivered under private or public programs.

A chief source of pressure on State budgets is the growth of state Medicaid costs for lower income citizens. In terms of overall Medicaid fraud, card sharing and phantom billing account for as much as $60 billion of current Medicaid costs. Medicaid fraud has two aspects: one, by the patient—attempting to receive care but not eligible due to ineligibility or illegality as in not being a citizen, and two, by the provider—through billing the system improperly for services rendered.

The present invention is directed to overcoming the problems discussed above.

### SUMMARY OF THE INVENTION

In accordance with the invention, a system and method are provided for determining eligibility of a card holder at a point of service.

In accordance with one aspect of the invention there is disclosed a method for determining eligibility of a card holder at a point of service by accessing eligibility information stored at a select application database, comprising the steps of: providing an individual with an identification card having a printed code identifying the card holder; operating a code server comprising a code database correlating card holder specific code record IDs and corresponding addresses associated with the select application database for providing eligibility information; operating a processing device at the point of service to: read the card holder's printed code; convert the card holder's printed code to a code record ID; and establish communication with the code server to transfer the card holder's code record ID to the code server; the code server comparing the received code record ID to the code database and returning the address corresponding to the received code record ID to the processing device; and operating the processing device to log onto the application database and use the returned address to download the eligibility information for display on the processing device at the point of service.

In accordance with another aspect of the invention, there is disclosed a system for determining eligibility of a card holder at a point of service by accessing eligibility information stored at a select application database. The system comprises a card holder identification card having a printed code identifying the card holder. A code server comprises a code database correlating card holder specific code record IDs and corresponding addresses associated with the select application database for providing eligibility information. A processing device at the point of service is programmed to: read the card holder's printed code; convert the card holder's print code to a code record ID; and establish communication with the code server to transfer the card holder's code record ID to the code server. The code server is programmed to compare the received code record ID to the code database and return the address corresponding to the received code record ID to the processing device. The processing device is programmed to log onto the application database and use the returned address to download the eligibility information for display on the processing device at the point of service.

It is a feature of the invention that the printed code comprises a three dimensional bar code.

It is another feature of the invention that the processing device comprises a code reader application that reads the card holder's printed code and determines that the printed code is valid before converting the card holder's printed code to the code record ID.

The processing device establishes communication with the code server and/or the application database over a computer network, such as the Internet.

In accordance with the invention, the code server may return a string to the processing device containing a URL associated with the received code record ID. The URL contains identifying information required to retrieve the card holder's eligibility information.

It is another feature of the invention that the code server stores transactional information responsive to receiving a code record ID including information identifying the processing device.

It is a further feature of the invention that the processing device comprises a smart phone having a camera for reading the printed code or a computer having a digital imaging device for reading the printed code.

It is still a further feature of the invention that the eligibility information may comprise an image of the card holder and data unique to the card holder.

Further features and advantages of the invention will be readily apparent from the specification and from the drawings.

### BRIEF DESCRIPTION OF THE DRAWINGS

FIG. 1 is a generalized view of an identification card having a printed code identifying the card holder in accordance with the invention;

FIG. 2 is a block diagram of a system for determining eligibility of a card holder at a point of service in accordance with the invention; and

FIGS. 3-5 comprise a flow diagram illustrating operation of the system of FIG. 2.

### DETAILED DESCRIPTION OF THE INVENTION

The application is described in detail relative to its use with a Medicaid program but the system and method described herein can be used for any and all eligibility needs for, including but not limited to, government, public and private companies, insurers, and other providers of services and programs.

The invention disclosed herein comprises a means and method for transmitting eligibility information relative to eligibility as a recipient of Medicaid or other insured services from a select database, such as a State computer system, to a Medicaid, private insurance or other provider of services. An individual's eligibility information is stored in the State's computer system, and the information is sent to authorized users as needed. The card holder is provided a URL that is assigned to a bar code that responds to a form of bar code recognition technology. The bar code can be scanned by appropriate personnel with an appropriate scanner or other digital imaging device. The scanned bar code is authenticated by the scanning device's application and code sever, and the information corresponding to that individual recipient is sent back to the scanning decive for use by the appropriate personnel. The eligibility information is sent to any approved party authorized to receive it. The entire process requires authentication of the requesting personnel and validation of the bar code for security purposes.

In accordance with the invention, an unique individualized three-dimensional (3D) color bar code, using X and Y positioning with a color as the Z value, is printed on each State issued Medicaid ID card (as will be apparent, the present invention is not limited to use with 3D bar codes). This gives the State the ability to include and deliver information to a provider of Medicaid services and other appropriate authorized parties. The information delivered by the attendant application through use of the bar code can be continually and automatically updated, changed, modified or amended, can increase/decrease the number of personal identifiers and/or change the eligibility status, validate and approve use status of the card holder in real time. Therefore, the invention accomplishes: (i) eliminating the possibility of someone falsely claiming to be eligible for Medicaid and other services and wrongfully receiving such services provided through the State; and, (ii) eliminating the need and cost of cancelling ID cards when the card holder is no longer approved to receive the services and having to reissue a new ID card when they become eligible to again receive such services; (iii) eliminating the cost of printing new ID cards for eligibility on a monthly basis; and, (iv) insures that a card holder receives the benefit of other services and government programs he/she is entitled to participate in by identifying, tracking and verifying the card holders participation in other governmental funded services and programs designed to provide the card holder with needed additional services he/she is entitled to receive.

In using 3D bar codes with bar code recognition technology, the systems and methods described herein will interface with the State's network of secured computer systems. The State will be enabled to; (i) provide current and updated personal identifiers indicating the eligibility for services status of each card holder; (ii) track the card holders visits for Medicaid and other Social Service and programs participation; and, (iii) can link and share a card holder's eligibility information with other state and local government databases.

As described more particularly below, the system implements an application that processes the bar code image and outputs a code record ID. This ID is transmitted to a code server through the use of, for example, a camera equipped mouse or a webcam attached to a PC, or other digital imaging device, using the web or secure network connection to access the eligibility information. The code server determines the Content Location Value (URL) associated with the code record ID and transmits it back to the application. The application launches the device's browser with the URL and connects to the appropriate computer system for the State's Medicaid system, or the like. Information is retrieved from Internal Content Database(s) located on the State's server(s) connected to secure internal network; and, if required, External Content Database(s) located on other State or local government servers connected to secure external networks or the internet. Eligibility information is retrieved from the Database(s) and assembled into single presentation layer. Assembled information is transmitted back to the requesting device—a PC or mobile device using the web or secure network connection to the State and local government servers to access the requested information.

The printed 3D bar code, requesting device and application do not contain or retain any of the information provided from the State government computer systems. Once viewing the information has been completed, the secured network connection is terminated and all information remains in the State secured computer systems.

The disclosed solution comprises a “pro-active” approach to the problem of Medicaid

Fraud that focuses on certifying card holder eligibility to reduce fraud. In an exemplary embodiment, the system uses 3D color bar code recognition, technology and printed 2D and/or 3D color bar codes to certify eligibility at the point of service and prior to delivery of service.

Particularly, the system utilizes printed codes on Medicaid Identification Cards—codes that when “read” by a mobile device, or computer connected to a webcam, camera equipped mouse or other digital imaging device, provides access to card holder information and displays it on a viewable screen. The solution is superior in terms of cost and ease of management to so-called “smart cards” which require costly “readers” on the desks of the providers and/or software that requires expensive provider training and implementation.

This approach gives states an efficient, effective and economical way to identify and certify that a card holder is, in fact, eligible for benefits. In so doing, it offers states another way to help solve the problem of Medicaid Fraud and produce sizable savings for state Medicaid programs.

The system includes built-in tracking, metrics and analytic tools. The 3D bar code is used to give users, companies, governmental agencies and individuals access to data that can help them make effective decisions about information processing and expenditures. The systems dynamic technology allows changes of information at any time, enabling States to react and evolve in real-time and deliver up-dated correct and timely data.

The 3D bar code decoding module is composed of a set of image processing, analyzing and decoding algorithms for distribution on mobile devices or computers. The decoding module operates under various lighting conditions through the use of a low-cost digital camera, limited processing power and memory usage of mobile phones, such as smart phones, or computers.

Unlike 2D barcodes which are presented in black and white, the 3D bar codes can be generated in a combination of black, white and various other color combinations and can be expressed in various designs according to changes in color and shape cells.

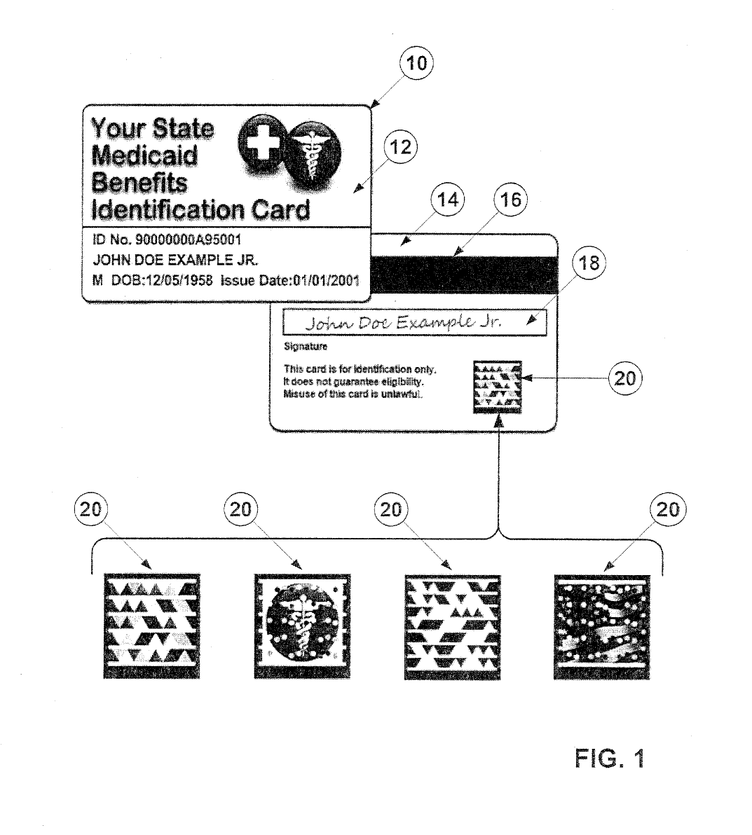

FIG. 1 illustrates an ID card 10 for use with the system and method in accordance with the invention. In the illustrated embodiment of the invention, the ID card 10 comprises a State Medicaid benefits identification card. The card includes a front side 12 and a back side 14. The front side 12 may include an ID number for the card holder, the card holder's name, date of birth and issue date. The back side 14 may include a conventional encoded magnetic stripe 16, a signature block 18 and a printed code 20 identifying the card holder. There are numerous different types of printed codes that can be used, such as a standard 2D bar code. In accordance with the invention, the printed code 20 may be a 3D color bar code using X and Y positioning with a color as the Z value on the card. The printed code can be decoded to provide a code record ID associated with the card holder. The printed code 20 may take one of numerous different forms, as illustrated. The present invention is not directed to the printed code specifically, but rather to a system and method which uses the printed code to determine eligibility of a card holder possessing the ID card 10 at a point of service.

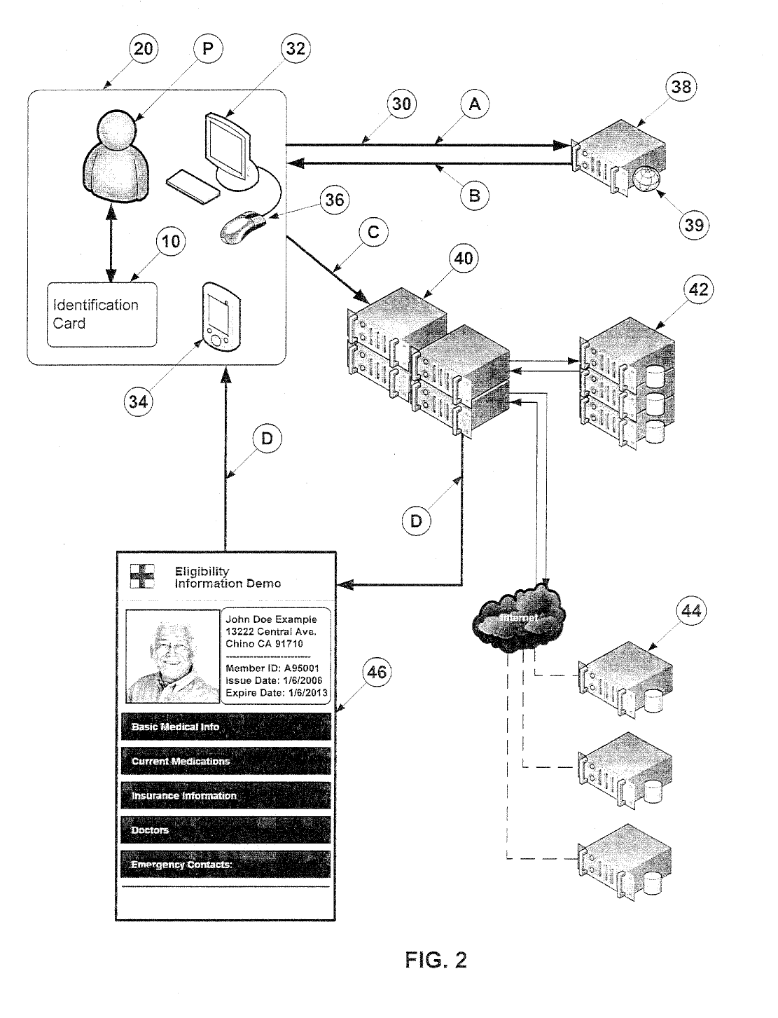

Referring to FIG. 2, a block diagram illustrates a system 30 in accordance with the invention for determining eligibility of a card holder at a point of service 20. The point of service 20 can be, for example, a physician's office, a hospital or other medical facility, or any location of an emergency service provider or the like. The ID card 10 is presented to a provider P. The provider P will have access to a conventional computer 32 or smart phone 34, or the like. The computer 32 may include a mouse 36 having a built in camera, or a separate webcam, or other digital imaging device. The smart phone 34 will have a camera. Either the smart phone 34 or the personal computer 32 will include a code reader application or “app” configured to operate in the system 30. The code reader app is adapted to read the printed code 20, see FIG. 1. Particularly, the computer 32 or smart phone 34 reads the printed code so that the information encoded into the printed code becomes available on the computer 32 or smart phone 34.

As will be apparent, the computer 32 can be a desktop computer, a laptop computer or any other type of computer capable of having an image reading input device for scanning the printed code 20 and performing the processing required to implement the functionality described herein. Likewise, the smart phone 34 can be of any conventional design also capable of performing the processing required to implement the functionality described herein.

The computer 32 and/or the smart phone 34 are operatively connected to a code server 38. The code server 38 comprises a programmed computer or device on a network that manages files stored on a code database 39. The code server 38 includes built-in tracking, metrics and analytic tools. The connection between the point of service 20 and the code server 38 may be provided via any available communication network, such as a cellular phone network, a computer network, including the Internet, or various other means for communication. The code server 38 includes the code database 39 which correlates card holder specific code record ID numbers and corresponding URL addresses. Each URL address is associated with an application server 40 and includes identifying information for the card holder. This identifying information is used to access eligibility information. As will be apparent, each State Medicaid office, private insurer, or other provider of services may have its own independent application server. Only one application server 40 is illustrated herein.

The application server 40 is operatively connected to the computer 32 and/or smart phone 34, via any known communication means, as with the code server 38. The application server 40 is programmed to retrieve information regarding the card holder and eligibility of the card holder for a particular good or service. The application server 40 is described herein in the context of a State Medicaid eligibility function. As such, the application server 40 would be operated by the State and retrieve eligibility information for authorized card holders. The application server 40 utilizes Internal Content Databases 42 and External Content Databases 44. As will be appreciated, the application server 40 and Content Databases 42 and 44 would be operated by the entity providing eligibility information.

Information flow using the system 30 is now described. Initially, the eligibility ID card 10 is presented and scanned by the camera equipped mouse 36, or webcam, or smart phone 34, or other digital imaging device. The code reader application processes the printed code 20, to determine the code record ID and initiates a communication channel with the code server 38 over lines A and B. The code reader app outputs the code record ID on the line A to the code server 38. The code server 38 accesses its code database 39 and determines the content location value (URL) associated with the code record ID and transmits the URL back to the code reader app on the line B. The code reader app launches the device's browser with the URL and connects it to the appropriate application server 40 on a line C. The application server 40 retrieves eligibility information from the Content Databases 42 and/or 44 and assembles the information into a single presentation layer. Once the information is retrieved by the application server 40, the assembled information is transferred on a line D back to the point of service 20 for display on the smart phone 34 or computer 32. An example of eligibility information for display is shown at 46. This displayed information can include a photograph of the card holder along with generalized information such as name, address, member ID, issue date and expiration date along with medical information as necessary or desired. The provider P at the point of service 20 can use this information to verify eligibility and that the information is consistent with the information provided on the ID card 10 and the photograph matches the card holder in possession of the ID card 10.

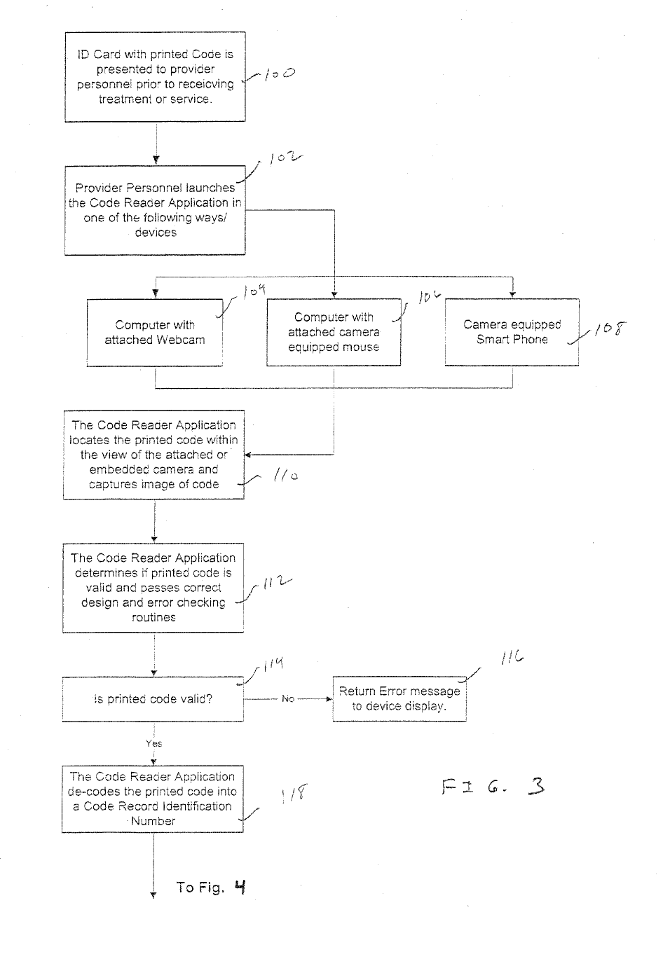

FIGS. 3-5 comprise a flow diagram illustrating sequence of operation for the various programs on the computer 32, the smart phone 34, the code server 38 and the application server 40 for transmitting personal identification information, relative to eligibility as a recipient of Medicaid or other insured services, from a select database to a provider of services.

The process begins at a block 100 where an ID card 10 with a printed code 20 is presented to provider personnel P prior to receiving treatment or service. The provider personnel P use the ID card 10 to obtain the eligibility information as described herein, rather than relying simply on the identity of the card holder. The provider P launches the code reader application at a block 102. The code reader application can be launched on a computer with attached web cam at a block 104, a computer with attached camera equipped mouse at a block 106 or a camera equipped smart phone 108. At a block 110, the code reader application locates the printed code 20, see FIG. 1, within the view of the attached or embedded camera and captures an image of the printed code. The code reader application determines if the printed code 20 is valid at a block 112 and that it passes correct design and error checking routines conventional for such printed codes 20. A decision block 114 determines if the printed code is valid. If not, an error message is returned to the device display at a block 116 and the routine ends. If the printed code 20 is valid, then the code reader application decodes the printed code into a code record ID number at a block 118.

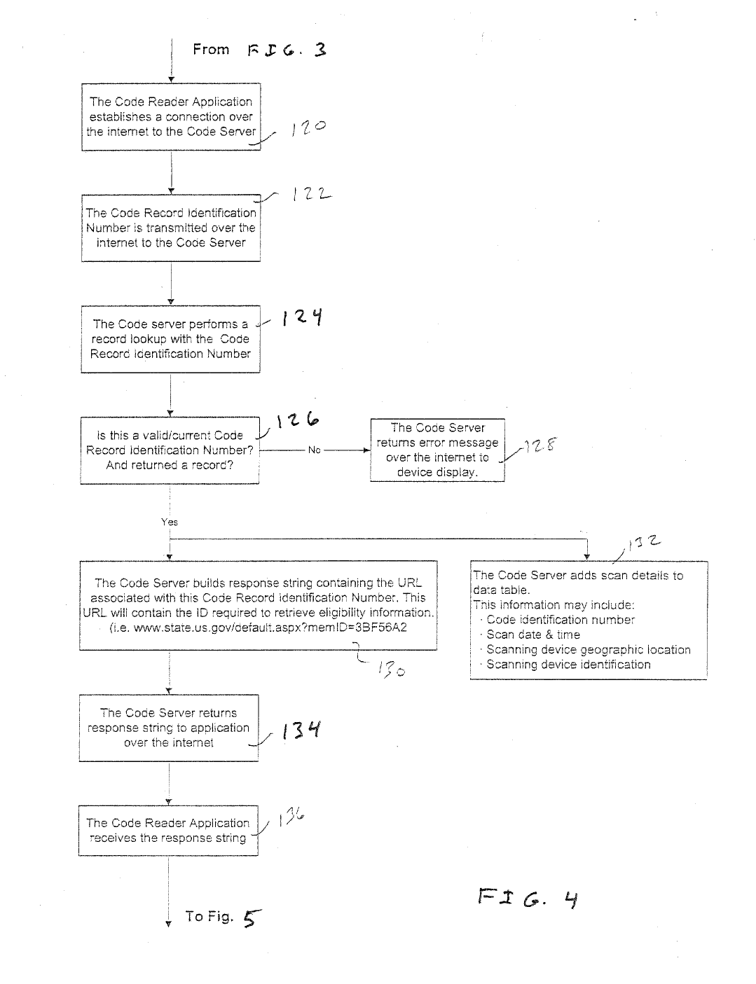

Moving to FIG. 4, from the block 118, the code reader application establishes a connection over the Internet, or otherwise, with the code server 38 at a block 120. The code reader application transmits the code record ID number to the code server 38 at a block 122. At a block 124, the code server 38 performs a record look up in its code database 39 using the code record ID number. A decision block 126 determines if the code record ID number is valid and current. The code server 38 also determines if a record has been returned. If not to any of these options, then the code server 38 returns an error message to the code reader application at a block 128 and the routine ends. If the code record ID number is valid and current and a record has been returned, then the code server 38 builds a response string containing the URL associated with this code record ID number at a block 130. The URL will contain the ID required to retrieve eligibility information for the card holder, as shown. The code server 38, at a block 132, will add scan details to the code database 39. This information may include the code record ID number, the scan date and time, the geographic location of the computer 32 or smart phone 34 as well as a unique scanning device identification code. This information can be used as a record of how and when the system 30 has been accessed.

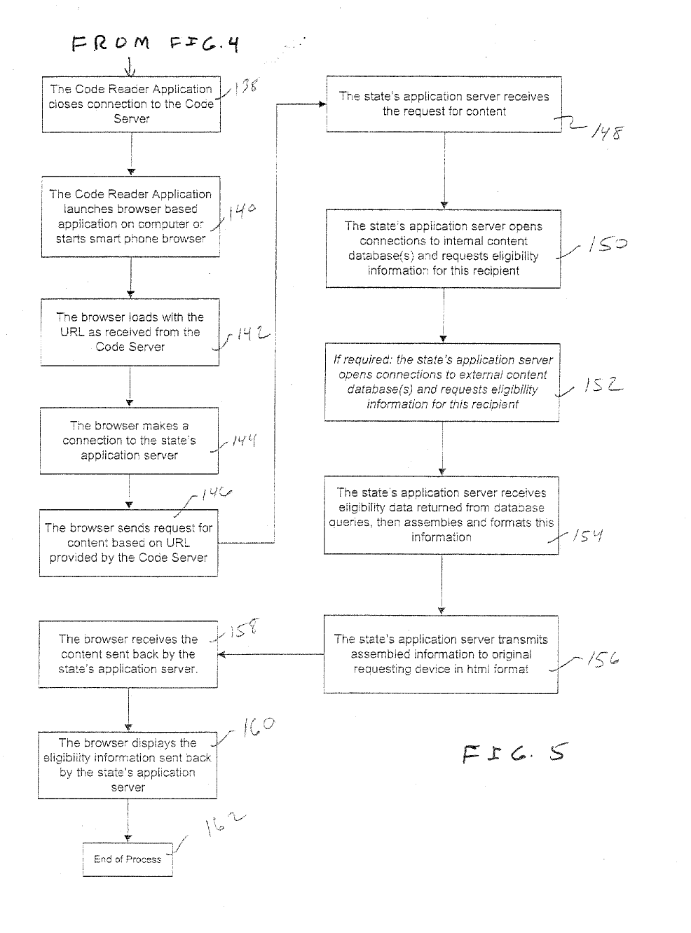

The code server 38 returns the URL response string to the code reader application at a block 134. The code reader application receives the response string at a block 136. The program flow proceeds to FIG. 5.

At a block 138, the code reader application closes the connection to the code server 38. The code reader application then launches a browser based application on the computer 32 or starts the smart phone browser at a block 140. At a block 142 the browser loads the URL received from the code server 38 and the browser makes a connection to the State's application server 40 at a block 144. The browser sends a request for content, based on the URL provided by the code server 38, at a block 146. This request for content is received by the State's application server 40 at a block 148. The State's application server 40 opens connections to the Internal Content Databases 42 and requests eligibility data for the card holder at a block 150. If required, then the State's application server 40 opens connections to the External Content Databases 44 and requests eligibility data therefrom for the card holder at a block 152. The eligibility data is received by the State's application server 40 at a block 154. This data can be from database queries to any of the Content Databases 42 or 44. The State's application server 40 assembles and formats this data which is transmitted to the requesting device in HTML format at a block 156. The browser at the computer 32 or smart phone 34 receives the content sent back by the State's application server 40 at a block 158 and displays the eligibility information, see 46 at FIG. 2, at a block 160. The routine then ends at a node 162.

There are various levels of security provided in the disclosed system. The actual URL of the content resides in the code server 38 and not within the printed code 20. Thus, no information is revealed if someone decodes, hacks or reverse engineers the printed code 20. It is simply a record number which is provided to the code server 38. Data transferred to and from the State's application server 40 can be secured by SSL certificates, and/or encrypted. These devices would utilize existing security framework in place for Internet and network access. Likewise, the personnel provider P may be required to log into the State's application server 40 using a user ID and password. This log in can be provided as part of the browser making a connection to the State's application server at the block 144, see FIG. 5, as will be apparent.

Using bar code recognition technology in concert with the disclosed eligibility and identity verification application, can help prevent fraud costs in these areas. The code reader application enables card holder eligibility confirmation for Medicaid recipients at point of service. The bar code (printed in ink on paper or a card) can be scanned by a cell phone camera, web-cam or a very inexpensive mouse with an embedded camera. This eliminates the need for expensive bio-metric or smart cards and readers.

The system accesses securely stored data on remote servers and displays that data on a computer screen or phone screen. The data can include photographs and other data unique to an eligible recipient. The data can be revised or updated and accessible in real time to deliver updated, correct, and timely data. The 3D bar code only contains digital pathway information. Content resides in the State's application server, under the State's control, thus eliminating many concerns about security and privacy.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

I claim:

1. A method for determining eligibility of a card holder at a point of service by accessing eligibility information stored at a select application database, comprising the steps of:
providing an individual with an identification card having a printed code identifying the card holder;
operating a code server comprising a code database correlating card holder specific code record IDs and corresponding addresses associated with the select application database for providing eligibility information defining card holder eligibility;
operating a processing device at the point of service to: read the card holder's printed code; convert the card holder's printed code to a code record ID; and establish communication with the code server to transfer the card holder's code record ID to the code server;
the code server comparing the received code record ID to the code database and returning the address corresponding to the received code record ID to the processing device; and
operating the processing device to log onto the application database and use the returned address to download the eligibility information for display on the processing device at the point of service.

2. The method of claim 1 wherein the printed code comprises a three dimensional bar code.

3. The method of claim 1 wherein the processing device comprises a code reader application that read the card holder's printed code and determines that the printed code is valid before converting the card holder's printed code to the code record ID.

4. The method of claim 1 wherein the processing device establishes communication with the code server over a computer network.

5. The method of claim 1 wherein the processing device establishes communication with the code server and the application database over the Internet.

6. The method of claim 1 wherein the code server returns a string to the processing device containing a URL associated with the received code record ID, the URL containing identifying information required to retrieve the card holder's eligibility information.

7. The method of claim 1 wherein the code server stores transactional information responsive to receiving a code record ID including information identifying the processing device.

8. The method of claim 1 wherein operating a processing device at the point of service comprises using a smart phone having a camera for reading the printed code.

9. The method of claim 1 wherein operating a processing device at the point of service comprises using a computer having a digital imaging device for reading the printed code

10. The method of claim 1 wherein the eligibility information comprises an image of the card holder and data unique to the card holder.

11. A system for determining eligibility of a card holder at a point of service by accessing personal identification information stored at a select application database, comprising:
a card holder identification card having a printed code identifying the card holder;
a code server comprising a code database correlating card holder specific code record IDs and corresponding addresses associated with the select application database for providing personal identification information defining card holder eligibility;
a processing device at the point of service being programmed to: read the card holder's printed code; convert the card holder's printed code to a code record ID; and establish communication with the code server to transfer the card holder's code record ID to the code server;
wherein the code server is programmed to compare the received code record ID to the code database and return the address corresponding to the received code record ID to the processing device; and
the processing device is programmed to log onto the application database and use the returned address to download the personal identification information defining card holder eligibility for display on the processing device at the point of service.

12. The system of claim 11 wherein the printed code comprises a three dimensional bar code.

13. The system of claim 11 wherein the processing device comprises a code reader application that read the card holder's printed code and determines that the printed code is valid before converting the card holder's printed code to the code record ID.

14. The system of claim 11 wherein the processing device establishes communication with the code server over a computer network.

15. The system of claim 11 wherein the processing device establishes communication with the code server and the application database over the Internet.

16. The system of claim 11 wherein the code server returns a string to the processing device containing a URL associated with the received code record ID, the URL containing identifying information required to retrieve the card holder's eligibility information.

17. The system of claim 11 wherein the code server stores transactional information responsive to receiving a code record ID including information identifying the processing device.

18. The system of claim 11 wherein the processing comprises a smart phone having a camera for reading the printed code.

19. The system of claim 11 wherein the processing device comprises a computer having a digital imaging device for reading the printed code

20. The system of claim 11 wherein the eligibility information comprises an image of the card holder and data unique to the card holder.
